(19) United States
(12) Patent Application Publication
(10) Pub. No.: US 2007/0144974 A1
(43) Pub. Date: Jun. 28, 2007

(54) Method of reducing trace organic matter in ultrapure water and system therefor

(75) Inventors: Kon-Tsu Kin, Chu-Tung (TW); Pei-Lin Chang, Chu-Tung (TW); Chien-Hung Chen, Chu-Tung (TW); Chiou-Mei Chen, Chu-Tung (KR)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/640,179

(22) Filed: Dec. 18, 2006

(30) Foreign Application Priority Data
Dec. 23, 2005 (TW) 94146154

(51) Int. Cl. C02F 1/46

(52) U.S. Cl. 210/663; 210/748; 210/758

(57) ABSTRACT

A method and system for reducing trace organic matter from ultrapure water is applied to removal of trace organic matter from ultrapure water having a total organic carbon (TOC) level less than 1ppb, so as to avoid leaching of trace organic matter from the ion exchange resin used in the system. The trace organic matter in the ultrapure water is degraded into charged ions, and further treated with a continuous electrodeionization unit to remove the charged ions, so as to reduce the TOC level and increase the resistance value of the ultrapure water.

### FIELD OF THE INVENTION

The present invention relates to a method and system for treating ultrapure water, and more particularly to a method and system for reducing trace organic matter in ultrapure water.

### BACKGROUND OF THE INVENTION

Following the rapid development in electronic industrial field, a large amount of highly pure water is needed for washing electronic components. Such highly pure water is particularly needed in integrated circuit (IC) industry. Therefore, techniques for producing highly pure water are constantly developed in an attempt to remove as much impurities as possible from water.

With the constantly developed high-tech manufacturing processes and equipment, there are high demands for higher quality ultrapure water. However, ultrapure water treated with the existing ultrapure water treatment technique has almost reached the theoretical limits therefor. For example, ultrapure water at 25° C. should have a theoretical resistance value of 18.25 MΩ·cm, and the ultrapure water produced by existing ultrapure water production plants already has a resistance value as high as 18.2 MΩ·cm. Therefore, it is truly a big challenge in further upgrading the quality of ultrapure water. Moreover, with the largely reduced wire width in the electronic and semiconductor manufacturing process, and the fact that about 95% of contaminants in the ultrapure water come from organic matter, there is a very strict limit to the total organic carbon (TOC) level in the ultrapure water.

To meet the future requirements for the purity of ultrapure water, it is very important for the existing ultrapure water production system to solve the problem of leached organic matter in the water treatment units in the system. When the purity of ultrapure water approaches to the limit thereof, the elements, pipes, and valves in the ultrapure water production system all are possible contamination sources of trace organic leach. In the currently available ultrapure water treatment system, when the ultrapure water has a TOC level less than 1 ppb, the unregenerated resin in the system has significant TOC leach to contaminate the water. This is because in the conventional ultrapure water system flow, the ion exchange resin does not remove the ions in the ultrapure water but holds the exchanged ions in its inner pores. Since ion exchange is a reversible process, it is possible for ions in the solution having been replaced with ion radicals in the ion exchange resin to migrate into the ultrapure water again. Further, since resin itself is an organic material, particularly a polymer matrix organic composite, it has the problem of micro-contamination by leached TOC.

It is therefore tried by the inventor to develop a method and system for reducing trace organic matter in ultrapure water, so as to avoid the problem of leached organic matter from ion exchange resin in the conventional ultrapure water treatment process, and to increase the resistance value of ultrapure water to more than 18 MΩ·cm.

### SUMMARY OF THE INVENTION

A primary object of the present invention is to provide a method and system for reducing trace organic matter in ultrapure water, in which a continuous electrodeionization unit is used to further reduce the TOC level in ultrapure water, so that the problem of significant leaching of trace organic matter in ultrapure water with a TOC level less than 1 ppb does not occur, and the resistance value of the ultrapure water is increased to be higher than 18 MΩ·cm.

The method of reducing trace organic matter in ultrapure water according to the present invention includes the steps of supplying ultrapure water containing trace organic matter; degrading the trace organic matter in the ultrapure water, so that the trace organic matter is dissociated into charged ions; and guiding the ultrapure water into a continuous electrodeionization unit to remove the charged ions.

In the degrading step of the method of the present invention, an advanced oxidation process, such as ultraviolet oxidation or ultraviolet/ozone oxidation, is used to degrade the trace organic matter in the ultrapure water.

The method of reducing trace organic matter in ultrapure water according to the present invention may further include the step of degassing the ultrapure water, so as to remove oxygen, carbon dioxide, or other volatile organic matter from the ultrapure water.

The continuous electrodeionization unit combines the electrodialysis technology and the ion exchange technology, and includes a plurality of ion-selective permeable membranes to divide a space between two electrodes into multiple alternately arranged concentrating compartments and desalting compartments. An ion exchange resin is disposed in the desalting compartments to enhance the dissociation of ions in water and enable absorption of ions. When the water is ionized to produce hydrogen ions and hydroxyl ions through electrolysis, the resin is continuously regenerated to increase its absorptive capacity and be reused again and again. On the other hand, the continuous electrodeionization unit is able to separate anions from cations in the water, and allows the cations or anions to selectively pass through the ion-selective permeable membranes. That is, the cations are allowed to pass through only the cation-selective permeable membranes while the anions are allowed to pass through only the anion-selective permeable membranes. And, electric current produced by external positive and negative electrodes forms a driving force to migrate ions. That is, the operating electric current of the continuous electrodeionization unit attracts charged ions to move into the concentrating compartments and gives the ultrapure water in the desalting compartments an increased purity.

In the system for reducing trace organic matter in ultrapure water according to the present invention, there is included an ultrapure water supplying unit, a degradation treatment unit, and a continuous electrodeionization unit. The ultrapure water supplying unit supplies ultrapure water containing trace organic matter. The degradation treatment unit degrades the ultrapure water supplied by the ultrapure water supplying unit, so that the trace organic matter in the ultrapure water is dissociated into charged ions. The continuous electrodeionization unit is used to remove the charged ions from the ultrapure water.

In an embodiment of the present invention, the degradation treatment unit may be an ultraviolet treatment unit or an ultraviolet/ozone treatment unit.

The system for reducing trace organic matter in ultrapure water according to the present invention may further include a degassing unit for removing oxygen, carbon dioxide, and other volatile organic matter from the ultrapure water.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a graph showing the leaching of organic matter from the unregenerated ion exchange resin when the feedwater has a low TOC level;

FIG. 2 is a flowchart showing the steps included in the method of reducing trace organic matter in ultrapure water according to an embodiment of the present invention;

FIG. 3 schematically shows the system for reducing trace organic matter in ultrapure water according to an embodiment of the present invention;

FIG. 4 is a diagram showing the structure of a continuous electrodeionization unit included in the system of the present invention;

FIG. 5 is a graph showing the relation between the pressure differential and the TOC level in the ultrapure water treated with the present invention; and

FIG. 6 is a graph showing the relation between the operating electric current and the TOC level in the ultrapure water treated with the present invention.

### DETAILED DESCRIPTION OF THE PREFERRED EMBODIMENTS

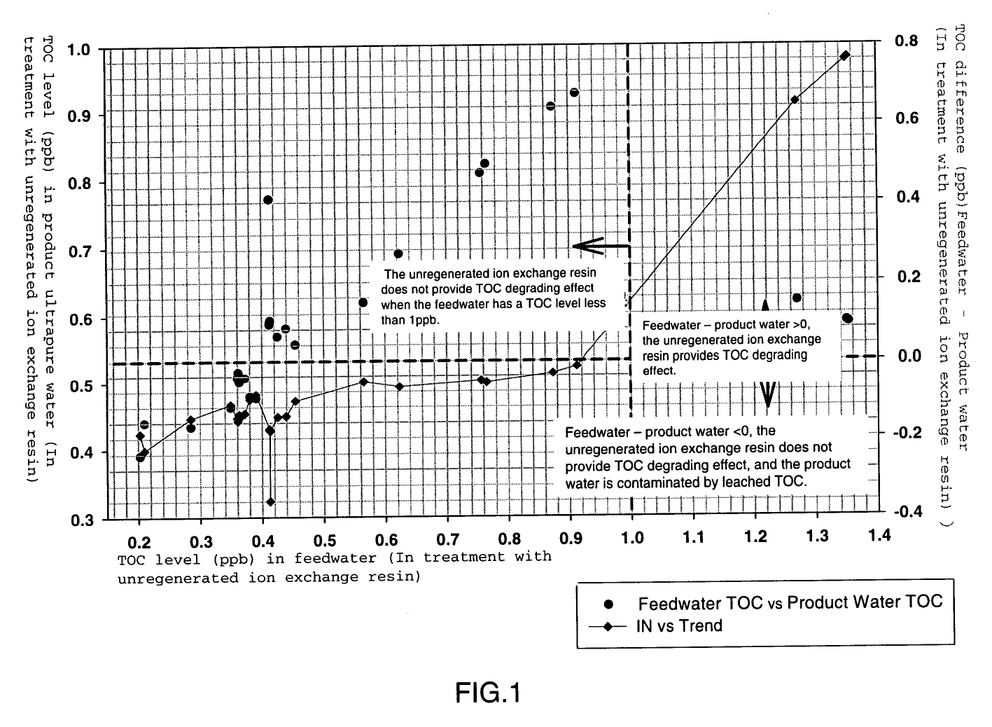

In a conventional ultrapure water production system, a total organic carbon (TOC) level in the ultrapure water is generally lower than 1 ppb. However, when the ultrapure water flows through an unregenerated ion exchange resin, the level of TOC tends to increase. FIG. 1 is a graph showing the leaching of organic matter from unregenerated ion exchange resin when the feedwater has a low TOC level. As shown, when the ultrapure water entered the unregenerated ion exchange resin has a TOC level lower than 0.5 ppb, the product water flown through the unregenerated ion exchange resin has an obviously increased TOC level, meaning that there is significant organic matter leached from the resin. And, when the feedwater has a TOC level within the range from 0.5 to 1.0 ppb, the product water has a slightly increased TOC level, and the TOC treatment does not give significant effect. However, when the feedwater has a TOC level larger than 1.0 ppb, the unregenerated ion exchange resin provides significant effect in the TOC treatment. Thus, when the feedwater to the unregenerated ion exchange resin has a TOC level lower than 1 ppb, there is a problem of leached organic carbon to adversely affect the quality of the product ultrapure water. However, to meet the increasingly strict requirements for water purity in the future, such as a TOC level lower than 0.4 ppb for 65 nm process technology, it necessitates us to discover new technologies and methods for solving the problem of leached organic carbon from the unregenerated ion exchange resin.

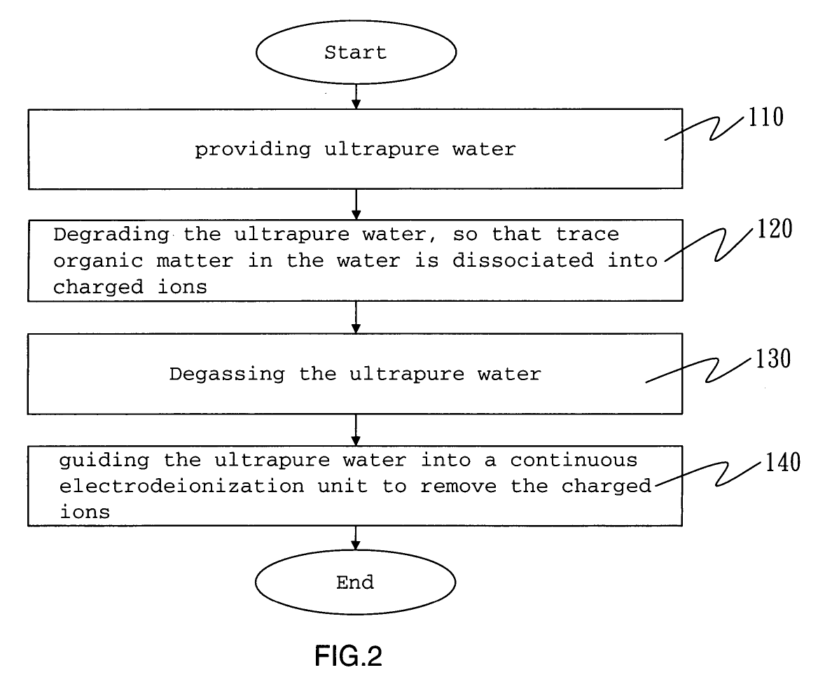

In one aspect of the present invention, there is provided a method of reducing trace organic matter in ultrapure water, so as to remove the trace organic matter from ultrapure water. The method of the present invention is particularly designed for ultrapure water having a TOC level lower than 1 ppb. Please refer to FIG. 2 that is a flowchart showing the steps included in the method of the present invention. As shown, in a first step (110), ultrapure water containing trace organic matter is supplied. In a second step (120), the trace organic matter contained in the ultrapure water is degraded, so that the trace organic matter is dissociated into charged ions. Advanced oxidation processes, such as ultraviolet oxidation, ultraviolet/ozone oxidation, etc., may be used to degrade the trace organic matter. In a third step (130), the ultrapure water is subjected to vacuum degassing treatment, so as to remove oxygen, carbon dioxide, and/or other volatile organic matter from the ultrapure water. Finally, in a fourth step (140), the ultrapure water is guided into a continuous electrodeionization unit, so as to remove the charged ions from the ultrapure water.

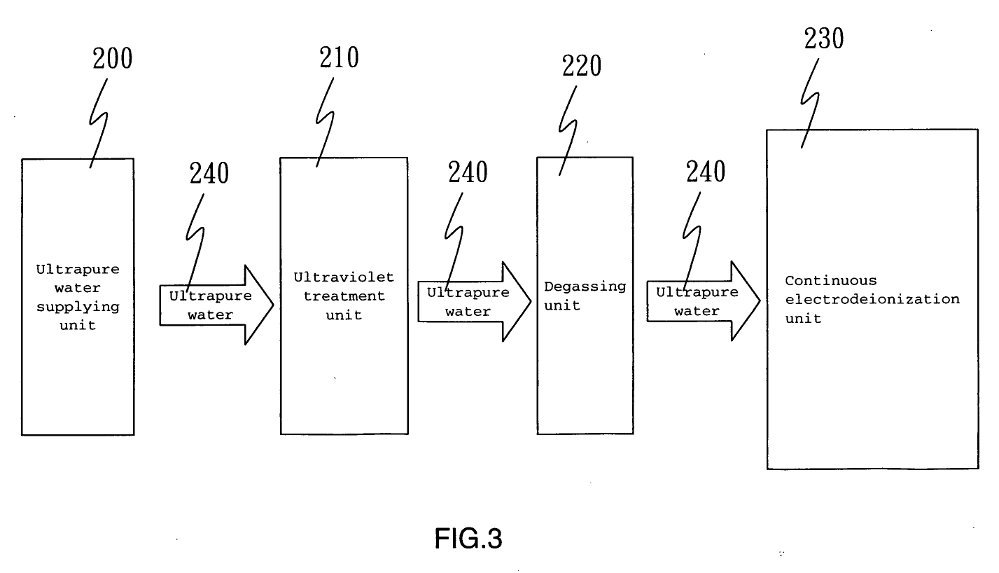

Please refer to FIG. 3 that schematically shows the system for reducing trace organic matter in ultrapure water according to an embodiment of the present invention. As shown, the system of the present invention includes an ultrapure water supplying unit 200, an ultraviolet treatment unit 210, a degassing unit 220, and a continuous electrodeionization unit 230. The ultrapure water supplying unit 200 supplies ultrapure water 240 that contains trace amount of organic matter and has a TOC level lower than 1 ppb. The ultraviolet treatment unit 210 is used to oxidize the ultrapure water 240 supplied by the ultrapure water supplying unit 200, so that the trace organic matter contained in the ultrapure water 240 are dissociated into charged ions. The degassing unit 220 is used to remove oxygen, carbon dioxide, or volatile organic matter from the ultrapure water 240. The continuous electrodeionization unit 230 is used to remove the charged ions from the ultrapure water 240. By following the method of the present invention as shown in FIG. 2, the ultrapure water 240 supplied by the ultrapure water supplying unit 200 is caused to flow through the ultraviolet treatment unit 210 to degrade the trace amount of organic matter into charged ions, and then flow through the degassing unit 220 to remove gases contained in the ultrapure water 240. Then, the degassed ultrapure water 240 further flows through the continuous electrodeionization unit 230 to remove the charged ions from the ultrapure water 240, so as to lower the TOC level in the ultrapure water 240 and increase the resistance value thereof.

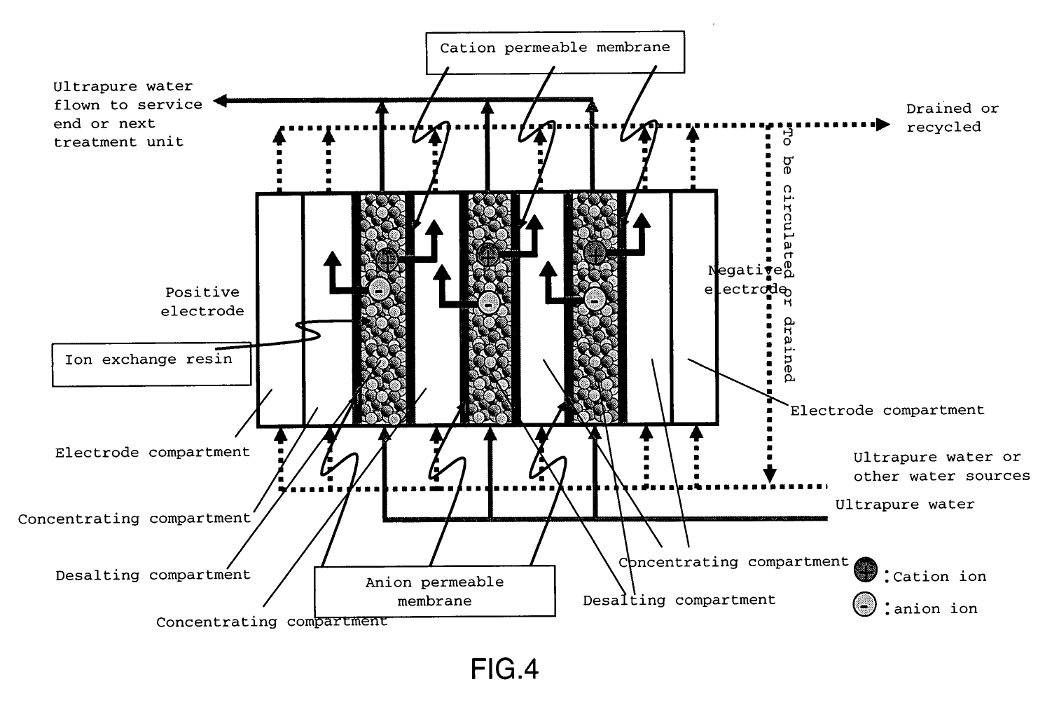

Please refer to FIG. 4. The continuous electrodeionization unit 230 includes a positive and a negative electrode, a plurality of ion-selective permeable membranes, an ion exchange resin, and a plurality of concentrating compartments and desalting compartments. A space between the positive and the negative electrode is divided by the ion-selective permeable membranes into a plurality of alternately arranged concentrating compartments and desalting compartments. The ion-selective permeable membranes located at one side of the desalting compartments closer to the positive electrode are anion exchange membranes that allow only anions to permeate therethrough, while the ion-selective permeable membranes located at the other side of the desalting compartments closer to the negative electrode are cation exchange membranes that allow only cations to permeate therethrough. The ion exchange resin is disposed in the desalting compartments to selectively replace the charged ions to be removed from the ultrapure water with ions in the resin. The positive and the negative electrode attract the charged ions in the desalting compartments, so that the charged ions pass through the ion-selective permeable membranes into the concentrating compartments. However, ions in the water in the concentrating compartments could not pass through the ion-selective permeable membranes into the desalting compartments. This gives the ultrapure water in the desalting compartments an increased purity, and the charged ions in the ultrapure water in the desalting compartments are directly moved to the concentrating compartments and removed away. Moreover, with the continuous electrodeionization unit, water molecule is electrolyzed into hydrogen ion (H⁺) and hydroxyl ion (OH⁻) to regenerate the ion exchange resin. The ion exchange resin may be a cation exchange resin, an anion exchange resin, or an unregenerated ion exchange resin.

The system for reducing trace organic matter in ultrapure water according to the present invention may be incorporated into any other pure water production systems. Thus, the ultrapure water supplying unit for the system of the present invention may be a pre-treatment system, a primary treatment system, an end-section circulation loop for a general pure water production system, or any other part of the general pure water production system that may supply ultrapure water to the system.

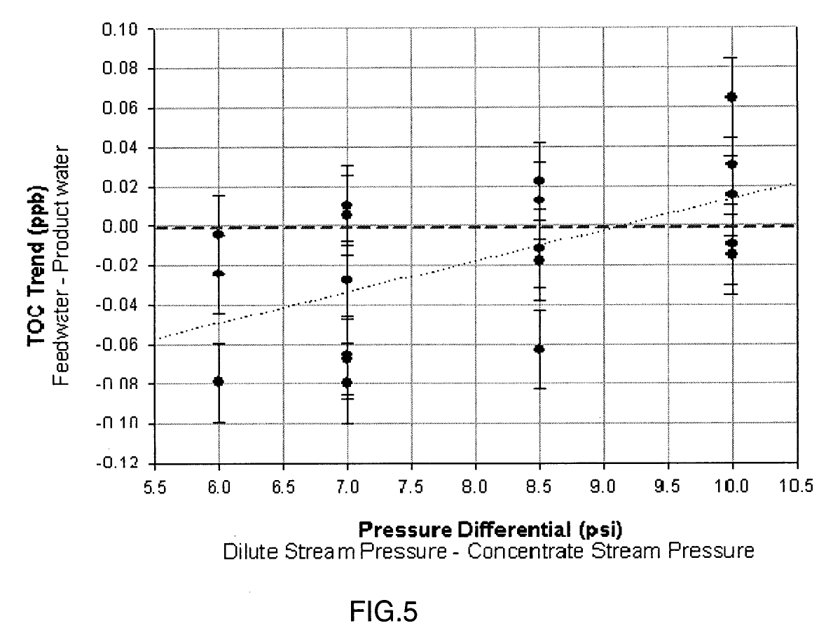

Experiments have been conducted to compare the water quality of ultrapure water treated with the method and system of the present invention under different pressure differential values between the desalting compartments and the concentrating compartments. From the experimental results, it is found the pressure differential value between the desalting compartments and the concentrating compartments has influence on the migration of charged ions, and pressure and amount of water passed through the concentrating compartments should not be larger than that of water passed through the desalting compartments. Please refer to FIG. 5 that is a graph showing the relation between the pressure differential and the TOC level in the ultrapure water treated with the present invention. In the experiments, the water pressure differential is adjusted by changing the pressure in the desalting compartments while the pressure in the concentrating compartments is set to a fixed value. The pressure differential is set to four different values of 6, 7, 8.5, and 10. And, the TOC levels in the product water at the above four pressure differential values are measured. From the experimental results, it is found the larger the pressure differential is, the higher the purity of the ultrapure water is.

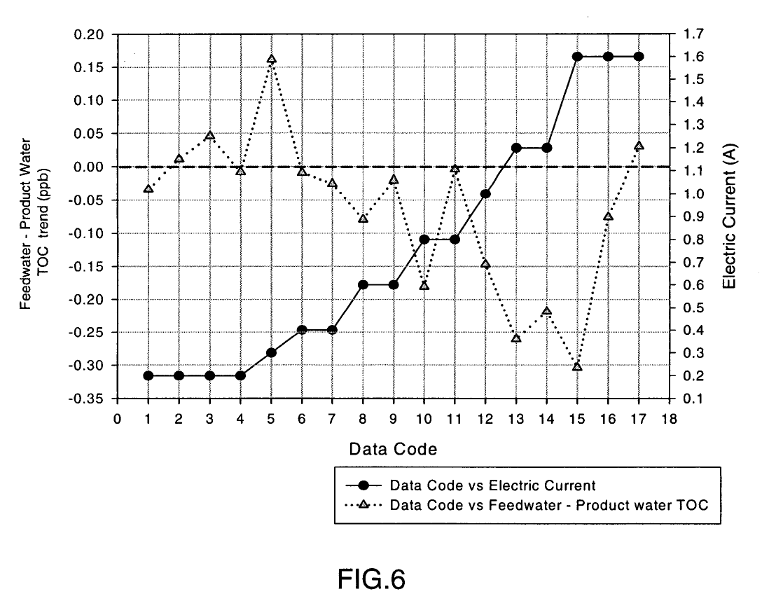

It is noted the operating electric current for the continuous electrodeionization unit is also an important parameter in the treatment according to the present invention. The amount of the operating electric current has direct influences on the hydrolytic effect and the quantity and speed of migrated charged ions. FIG. 6 is a graph showing the relation between the operating electric current and the TOC level in the ultrapure water treated with the present invention. In the experiments, the operating electric current amount is within the range from 0.2 A to 1.6 A. From the experimental results, it is found the continuous electrodeionization unit has better and relatively stable treatment effect when the operating electric current is between 0.1 A and 0.8 A.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of reducing trace organic matter in ultrapure water, comprising the steps of:
supplying ultrapure water containing a trace organic matter and having a total organic carbon (TOC) level less than 1 ppb and;
degrading the trace organic matter contained in the ultrapure water, so that the trace organic matter is dissociated into charged ions; and
guiding the ultrapure water into a continuous electrodeionization unit, so as to remove the charged ions from the ultrapure water.

2. The method of reducing trace organic matter in ultrapure water as claimed in claim 1, wherein, in the degrading step, an advanced oxidation process is used to degrade the trace organic matter.

3. The method of reducing trace organic matter in ultrapure water as claimed in claim 2, wherein the advanced oxidation process is selected from the group consisting of ultraviolet oxidation process and ultraviolet/ozone oxidation process.

4. The method of reducing trace organic matter in ultrapure water as claimed in claim 1, further comprising the step of degassing the ultrapure water after the degrading step.

5. The method of reducing trace organic matter in ultrapure water as claimed in claim 1, wherein the continuous electrodeionization unit includes:
a positive electrode and a negative electrode;
a plurality of ion-selective permeable membranes, which divide a space between the positive and the negative electrode into a plurality of alternately arranged concentrating compartments and desalting compartments; and
at least an ion exchange resin disposed in the desalting compartments, ions in the ion exchange resin being selectively exchanged against the charged ions in the desalting compartments, and the charged ions being attracted by the positive and the negative electrode to pass through the ion-selective permeable membranes into the concentrating compartments, giving the ultrapure water treated in the desalting compartments an increased purity.

6. The method of reducing trace organic matter in ultrapure water as claimed in claim 5, wherein the ion exchange resin is selected from the group consisting of cation exchange resin, anion exchange resin, and unregenerated ion exchange resin.

7. The method of reducing trace organic matter in ultrapure water as claimed in claim 5, wherein a pressure and quantity of the ultrapure water passing through the concentrating compartments is always smaller than that of the ultrapure water passing through the desalting compartments.

8. The method of reducing trace organic matter in ultrapure water as claimed in claim 1, wherein the continuous electrodeionization unit has an operating electric current between 0.1 A and 0.8 A.

9. A system for reducing trace organic matter in ultrapure water, comprising:
a ultrapure water supplying unit for supplying ultrapure water containing a trace amount of organic matter and having a TOC level less than 1 ppb;
a degradation treatment unit for degrading the ultrapure water supplied by the ultrapure water supplying unit, so that the trace organic matter contained in the ultrapure water is dissociated into charged ions; and
a continuous electrodeionization unit for removing the charged ions from the ultrapure water.

10. The system for reducing trace organic matter in ultrapure water as claimed in claim 9, wherein the ultrapure water supplying unit is selected from the group consisting of a pre-treatment system, a primary treatment system, and an end-section circulation loop of a pure water production system.

11. The system for reducing trace organic matter in ultrapure water as claimed in claim 9, wherein the degradation treatment unit is selected from a group consisting of an ultraviolet light treatment unit and an ultraviolet/ozone treatment unit.

12. The system for reducing trace organic matter in ultrapure water as claimed in claim 9, further comprising a degassing unit for removing gases contained in the ultrapure water.

13. The system for reducing trace organic matter in ultrapure water as claimed in claim 9, wherein the continuous electrodeionization unit includes:
a positive electrode and a negative electrode;
a plurality of ion-selective permeable membranes, which divide a space between the positive and the negative electrode into a plurality of alternately arranged concentrating compartments and desalting compartments; and
at least an ion exchange resin disposed in the desalting compartments, ions in the ion exchange resin being selectively exchanged against the charged ions in the desalting compartments, and the charged ions being attracted by the positive and the negative electrode to pass through the ion-selective permeable membranes into the concentrating compartments, giving the ultrapure water treated in the desalting compartments an increased purity.

14. The system for reducing trace organic matter in ultrapure water as claimed in claim 13, wherein the ion exchange resin is selected from the group consisting of cation exchange resin, anion exchange resin, and unregenerated ion exchange resin.

15. The system for reducing trace organic matter in ultrapure water as claimed in claim 13, wherein a pressure and quantity of the ultrapure water passing through the concentrating compartments is always smaller than that of the ultrapure water passing through the desalting compartments.

16. The system for reducing trace organic matter in ultrapure water as claimed in claim 13, wherein the continuous electrodeionization unit has an operating electric current between 0.1 A and 0.8 A.
